(19) United States
(12) Patent Application Publication
(10) Pub. No.: US 2009/0005917 A1
(43) Pub. Date: Jan. 1, 2009

(54) System and method of carbon monoxide and fire detection and protection

(76) Inventor: John L. Hole, Eagan, MN (US)

Correspondence Address: Gary L. Huusko, Suite 600, 7300 West 147th Street, Apple Valley, MN, 55124, US

(21) Appl. No.: 11/823,677

(22) Filed: Jun. 28, 2007

(51) Int. Cl. G08B 17/10

(52) U.S. Cl. 701/3

(57) ABSTRACT

A carbon monoxide and fire detection system and method are provided for vehicles, particularly light aircraft, which includes CO and smoke/heat detectors located in or near the pilot cabin that, in the event unsafe levels of CO is detected in the cabin or a fire is detected in the engine compartment, an electronic signal from the respective detector causes the heated ram-air and fresh-air control box valves to open or close to restrict heated air contaminated with CO and allow fresh-air into the cabin in the case of CO detection, or closing both valves thereby restricting a fire from entering the cabin through the heated ram-air or fresh air vents, as the case may be.

### FIELD OF THE INVENTION

This invention relates to a system and method of carbon monoxide and fire detection and protection for enclosed cabins, such as those in light aircraft, boats and automobiles.

### BACKGROUND OF THE INVENTION

Numerous accidents and deaths have been caused by carbon monoxide poisoning, particularly by carbon monoxide entering light aircraft, or other vehicles', cabins due to heating system failures. Toxic gases, such as carbon monoxide, do not need to reach lethal levels to seriously impair pilot performance. Sub-lethal exposures can cause even experienced pilots to make potentially fatal mistakes.

Typically, in most light aircraft, and in boats and automobiles that heat the enclosed cabin air similarly, heat to the cabin is generated by transfer of heat from the exhaust gases in the engine exhaust system to the cabin heating system. Outside air is directed around the exhaust muffler 12 in a metal box and further directed into the aircraft cabin by way of ducting through a soft, flexible plastic hose. The ducting hose typically has a spiral wire in it to hold its shape. At the firewall, or some other location along the ducting path, is a heat control box attached to the ducting with a valve that can open and close, thereby controlling the amount of heated air that can enter the cabin or passenger compartment. A compromised exhaust system, such as a leak in or around the exhaust muffler, will allow carbon monoxide to enter into the cabin heat system, thereby putting the pilot at risk of carbon monoxide poisoning. Likewise, a fresh-air control box is attached to the fresh-air system, also having a valve that can open and close and control the amount of fresh air that enters the cabin or passenger compartment. The ducting material would bum away very quickly in a fire, in essence giving the heat control box and the fresh-air control box a direct opening through the firewall into the cabin unless the heat control valve and fresh-air control valve are closed.

The valves are flat panels attached to a valve rod or shaft. The valve rod is free to rotate, thereby moving the valve. One end of the valve rod is attached to a fixed arm, which is attached to a control wire of a control cable. The control cable consists of the control wire in a shielding. The wire is thus free to slide within the shielding. The other end of the control cable is fixed at the instrument panel in the cabin. There is a knob attached to the control wire at the instrument panel end. When the knob is pulled or turned, it pulls the wire through the shielding toward the instrument panel, which moves the arm thereby rotating the valve to a closed position. Likewise, pushing or turning the knob in the opposite direction will open the valve. The current system requires pilot intervention to open close the valves on the fresh-air and the heated air control boxes.

It is the intent of the present invention to allow the fresh-air and heated air control valves to automatically open or close upon the detection of carbon monoxide, smoke or fire, as the case may be.

The subtle effects of carbon monoxide inhalation can cause physical incapacitation and subsequent death. Toxicologically, carbon monoxide combines with the hemoglobin in blood and interferes with the oxygen supply to tissues. The decreased oxygen level found in most fire scenarios further enhances the problem of getting enough oxygen to the biological sites to maintain normal function. Continued inhalation of these gases can result in severe hypoxia. At high altitude where oxygen levels are lower, the effects of carbon monoxide are greatly enhanced.

Carbon monoxide poisoning produces headache, weakness, nausea, dizziness, confusion, dimness of vision, disturbance of judgment, and unconsciousness followed by coma and death. Although carbon monoxide causes deleterious effects on the central nervous system, death usually occurs from cardio-toxicity. Not all symptoms will necessarily be experienced by every individual exposed to this gas. Some have died from inhaling low carbon monoxide levels, while others have survived breathing higher concentrations.

Current safeguards against carbon monoxide poisoning in light aircraft include CO detectors that will warn the pilot of unsafe levels of CO, and general aviation and FAA guidelines and instructions for pilot action in the event CO poisoning symptoms are experienced.

The current safeguards rely upon an alert pilot to take specific action to forestall or prevent the effects of CO poisoning. Expecting a pilot to follow a checklist is not, however, a reliable solution to CO poisoning.

This invention overcomes that shortcoming by automatically detecting unsafe levels of CO and automatically closing the intake of CO infected air and directing fresh air into the cabin, thereby preventing CO poisoning of the pilot and other occupants of the aircraft cabin.

### SUMMARY OF THE INVENTION

According to the present invention, the system automatically detects CO presence, closes the vehicle heat valve, and opens the vehicle fresh-air ventilation valve, without any required activity on the part of the vehicle pilot or other cabin occupant. Likewise, in the event the system detects smoke or heat from a fire, both the vehicle heat valve and vehicle fresh-air ventilation valve would be closed, thereby preventing the fire from entering the cabin.

### DESCRIPTION OF THE DRAWINGS

These and other claims of the present invention will be more fully understood by reading the following detailed description taken together with the drawings wherein:

FIG. 1 is a schematic drawing of the present invention system components.

### DETAILED DESCRIPTION OF THE DRAWINGS

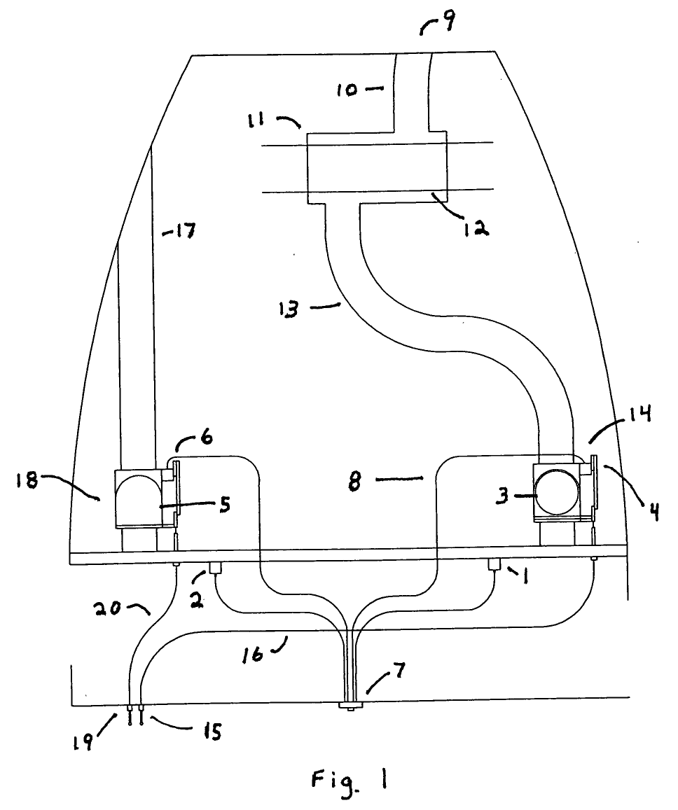

FIG. 1 shows the system components of the preferred embodiment of the present invention. The carbon monoxide and fire detection system includes at least one carbon monoxide (CO) sensor detector 1, at least one smoke/heat detector 2, a power source, a heater control valve 3, an electro-mechanical heater control valve switching means 4, a fresh-air control valve 5, an electro-mechanical fresh-air control valve switching means 6, an electronic control unit 7, and connecting wire 8 connecting the CO sensor detector 1, the smoke/heat detector 2, the power source, the heater control valve 3, the electro-mechanical heater control valve switching means 4, the fresh-air control valve 5, the electro-mechanical fresh-air control valve switching means 6 and the electronic control unit 7 together to form a circuit means.

Referring still to FIG. 1, a ram-air intake 9 is situated in the engine cowling to provide air pressure from the forward motion of the aircraft into a ram-air intake duct tube 10. The ram-air intake duct tube 10 directs the ram-air into a metal shroud 11 that surrounds an exhaust muffler 12. The ram-air is heated from passing by the exhaust muffler 12 and the heated ram-air is then directed by way of a heated ram-air duct 13 to a heater control box 14. Typically, the ram-air intake duct tube 10 and the heated ram-air duct 13 are a thin plastic flexible hose, although other air directing means and materials are also used.

In existing aircraft, the pilot is able to control the heated ram-air by directing the heated ram-air in the heater control box 14 into the aircraft cabin by way of a heated ram-air cabin inlet vent, or out of the aircraft by way of a ram-air outlet vent. The pilot controls the flow of the heated ram-air by pulling or pushing a heater control cable control 15, which then pulls or pushes a heater control cable 16 thereby opening or closing a cable driven heater control valve 3 within the heater control box 14, allowing more or less heated air into the aircraft cabin. Depending upon the configuration or the heater control cable control 15 and the heater control cable 16, the pilot may also open and close the heater control valve 3 by turning or sliding the heater control cable control 15.

A fresh-air inlet allows fresh air into the aircraft cabin through a fresh-air inlet tube 17, also a thin plastic flexible hose like the ram-air intake duct tube 10 and heated ram-air duct 13, which directs the fresh air into a fresh-air control box 18. Existing aircraft fresh-air is controlled manually by the pilot, the pilot controlling the fresh-air by directing the fresh-air in the fresh-air control box 18 into the aircraft cabin by way of a fresh-air cabin inlet vent. The pilot controls the flow of the fresh-air in a similar fashion as the heated ram-air, by pulling, pushing, turning or sliding a fresh-air control cable control 19, which then pulls or pushes a fresh-air control cable 20, thereby opening or closing a cable driven fresh-air control valve 5 within the fresh-air control box 18, allowing more or less fresh air into the aircraft cabin.

Thus, currently, the pilot is able to manually control the temperature within the cabin of the aircraft by pulling, pushing, turning or sliding the heater control cable 16 and fresh-air control cable control 19, thereby regulating the amount of heated ram-air or cool fresh-air into the cabin. The present invention allows for an automatic control of the heated ram-air and fresh-air entering the aircraft cabin.

Referring still to FIG. 1, a carbon monoxide sensor detector 1 is located within the cabin compartment such that detection of unsafe levels of CO occurs before any harmful symptoms are experienced by the pilot or other persons within the aircraft cabin. The CO sensor detector 1 is shown attached to the interior of the cabin on the firewall, behind the aircraft control panel, near the heated ram-air cabin inlet vent. The heated ram-air would pass by the CO sensor detector 1 prior to entering the main part of the aircraft cabin, thus allowing the CO sensor detector 1 to detect an unsafe level of CO in the heated ram-air. The CO sensor detector 1 could be placed at other locations as well, and, where multiple CO sensor detector 1s are used, would be placed in locations that would be optimal for detection of the first signs of CO.

The CO sensor detector 1 is electronically connected to the electronic control unit 7 by connecting wire 8, and is calibrated to send a CO detection signal to the electronic control unit 7 if the CO concentration reaches an unsafe level. The electronic control unit 7, electronically connected to the electro-mechanical heater control valve switching means by the connecting wire 8, then sends a first signal through the connecting wire 8 to the electro-mechanical heater control valve switching means on the heater control box 14 to close the heater control valve 3, thereby directing the heated ram-air outside of the aircraft. The electronic control unit 7 also messages the pilot by means of a sound or visual alarm, or both.

In another embodiment, a heater firewall valve with its own heater firewall electro-mechanical heater control valve switching means would be located at the firewall of the aircraft whereby the electronic control unit 7, electronically connected to the heater firewall electro-mechanical heater control valve switching means by the connecting wire 8, would send the first signal through the connecting wire 8 to the heater firewall electro-mechanical heater control valve switching means to close the heater firewall valve, thus preventing CO from entering the cabin.

The electronic control unit 7, also electronically connected to the electro-mechanical fresh-air control valve switching means by the connecting wire 8, sends a second signal through the connecting wire 8 to the electro-mechanical fresh-air control valve switching means on the fresh-air control box 18 to open the fresh-air control valve 5, thereby allowing fresh air to enter the aircraft cabin.

In another embodiment, a fresh-air firewall valve with its own fresh-air firewall electro-mechanical fresh-air control valve switching means would be located at the firewall of the aircraft whereby the electronic control unit 7, electronically connected to the fresh-air firewall electro-mechanical heater control valve switching means by the connecting wire 8, would send the second signal through the connecting wire 8 to the fresh-air firewall electro-mechanical fresh-air control valve switching means to open the fresh-air firewall valve, thus allowing fresh air to enter the cabin.

Where multiple CO detectors are used, each would be connected to the circuit means by the connecting wire 8, and each would independently send the first and second signals to the electro-mechanical heater control valve switching means and the electro-mechanical fresh-air control valve switching means.

Likewise, the smoke/heat detector 2 is located in the aircraft cabin compartment such that detection of smoke or heat occurs immediately when a fire is present and smoke enters the cabin compartment. The smoke/heat detector 2 is shown attached to the interior of the cabin on the firewall, behind the aircraft control panel. The smoke/heat detector 2 could be placed at other locations as well, and, where multiple smoke/heat detector 2s are used, would be placed in locations that would be optimal for detection of the first signs of smoke or fire. The smoke/heat detector 2 is electronically connected to the electronic control unit 7 by connecting wire 8, and is calibrated to send a smoke or heat detection signal to the electronic control unit 7 if smoke or heat is detected. The electronic control unit 7, electronically connected to the electro-mechanical heater control valve switching means by the connecting wire 8, then sends a third signal through the connecting wire 8 to the electro-mechanical heater control valve switching means on the heater control box 14 to close the heater control valve 3, thereby closing the valve, preventing fire from entering the cabin, and opening the overboard port. The electronic control unit 7 also messages the pilot by means of a sound or visual alarm, or both.

Likewise, in another embodiment, a heater firewall valve with its own heater firewall electro-mechanical heater control valve switching means would be located at the firewall of the aircraft whereby the electronic control unit 7, electronically connected to the heater firewall electro-mechanical heater control valve switching means by the connecting wire 8, would send the third signal through the connecting wire 8 to the heater firewall electro-mechanical heater control valve switching means to close the heater firewall valve, thus preventing fire from entering the cabin.

The electronic control unit 7, also electronically connected to the electro-mechanical fresh-air control valve switching means by the connecting wire 8, sends a fourth signal through the connecting wire 8 to the electro-mechanical fresh-air control valve switching means on the fresh-air control box 18 to close the fresh-air control valve 5, thereby preventing fire from burning through the thin plastic flexible hose, preventing fire and smoke from entering the fresh-air control box 18 and entering the cabin through the fresh-air port through the firewall.

Likewise, in another embodiment, a fresh-air firewall valve with its own fresh-air firewall electro-mechanical fresh-air control valve switching means would be located at the firewall of the aircraft whereby the electronic control unit 7, electronically connected to the fresh-air firewall electro-mechanical heater control valve switching means by the connecting wire 8, would send the fourth signal through the connecting wire 8 to the fresh-air firewall electro-mechanical fresh-air control valve switching means to open the fresh-air firewall valve, thus allowing fresh air to enter the cabin.

Should the CO detector activate, it would open the fresh-air valve. In the event of a fire, the fresh-air valve must be closed to prevent fire from burning through the flexible plastic fresh-air tubing and passing through the fresh-air control box 18 through the fire wall and into the cabin. The electronic control unit 7 would provide that any signal received from the smoke/heat detector 2 would at least temporarily over-ride any signal received from the CO sensor detector 1, closing (or holding closed) the fresh-air control valve 5.

I claim:

1. A system of carbon monoxide and fire detection and protection for a vehicle, comprising
at least one carbon monoxide (CO) sensor detector,
at least one smoke/heat detector,
an electronic control unit,
a power source,
a heater control valve,
an electro-mechanical heater control valve switching means,
a fresh-air control valve,
an electro-mechanical fresh-air control valve switching means, and
a connecting wire,
the connecting wire connecting the CO sensor detector, the smoke/heat detector, the power source, the heater control valve, the electro-mechanical heater control valve switching means, the fresh-air control valve, the electro-mechanical fresh-air control valve switching means and the electronic control unit together to form a circuit means,
the CO sensor detector being capable of sending a CO detection signal to the electronic control unit through the connecting wire,
the smoke/heat detector being capable of sending a fire detection signal to the electronic control unit through the connecting wire,
the electronic control unit comprising a first signal, a second signal, a third signal, a fourth signal and an over-ride signal means,
the electronic control unit, upon receiving the CO detection signal, sends the first signal through the connecting wire to the electro-mechanical heater control valve switching means on the heater control box to close the heater control valve, and sends the second signal through the connecting wire to the electro-mechanical fresh-air control valve switching means on the fresh-air control box to open the fresh-air control valve, thereby allowing fresh air to enter and ventilate the aircraft cabin,
the electronic control unit, upon receiving the fire detection signal, sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve, thereby closing the heater control valve and closing the fresh-air control valve to prevent fire from entering the cabin,
the electronic control unit, upon receiving both the fire detection signal and the CO detection signal, provides the over-ride signal means to disregard the CO detection signal and sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve.

2. The system of carbon monoxide and fire detection and protection for a vehicle of claim 1 wherein the over-ride signal means temporarily disregards the CO detection signal until such time as any fire is extinguished.

3. The system of carbon monoxide and fire detection and protection for a vehicle of claim 2 wherein the vehicle is a light aircraft.

4. A method of carbon monoxide and fire detection and protection for a vehicle, comprising
at least one carbon monoxide (CO) sensor detector,
at least one smoke/heat detector,
an electronic control unit,
a power source,
a heater control valve,
an electro-mechanical heater control valve switching means,
a fresh-air control valve,
an electro-mechanical fresh-air control valve switching means, and
a connecting wire,
the connecting wire connecting the CO sensor detector, the smoke/heat detector, the power source, the heater control valve, the electro-mechanical heater control valve switching means, the fresh-air control valve, the electro-mechanical fresh-air control valve switching means and the electronic control unit together to form a circuit means,
the CO sensor detector being capable of sending a CO detection signal to the electronic control unit through the connecting wire,
the smoke/heat detector being capable of sending a fire detection signal to the electronic control unit through the connecting wire,
the electronic control unit comprising a first signal, a second signal, a third signal, a fourth signal and an over-ride signal means,
the electronic control unit, upon receiving the CO detection signal, sends the first signal through the connecting wire to the electro-mechanical heater control valve switching means on the heater control box to close the heater control valve, and sends the second signal through the connecting wire to the electro-mechanical fresh-air control valve switching means on the fresh-air control box to open the fresh-air control valve, thereby allowing fresh air to enter and ventilate the aircraft cabin,
the electronic control unit, upon receiving the fire detection signal, sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve, thereby closing the heater control valve and closing the fresh-air control valve to prevent fire from entering the cabin,
the electronic control unit, upon receiving both the fire detection signal and the CO detection signal, provides the over-ride signal means to disregard the CO detection signal and sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve.

5. The method of carbon monoxide and fire detection and protection for a vehicle of claim 4 wherein the over-ride signal means temporarily disregards the CO detection signal until such time as any fire is extinguished.

6. The method of carbon monoxide and fire detection and protection for a vehicle of claim 5 wherein the vehicle is a light aircraft.

7. A system of carbon monoxide and fire detection and protection for a light aircraft, the light aircraft having a pilot and passenger compartment cabin, a heater system wherein ram-air is directed past an exhaust muffler, thereby heating the ram-air, and further directing the heated ram-air into the cabin compartment, the pilot having the ability to manually control the intake of heated air by a control cable means that is attached to a heated ram-air control box valve and that, by pushing or pulling, or otherwise moving the control cable means comprising
at least one carbon monoxide (CO) sensor detector affixed inside the light aircraft cabin,
at least one smoke/heat detector affixed inside the light aircraft cabin,
an electronic control unit,
a power source,
a heater control valve,
an electro-mechanical heater control valve switching means,
a fresh-air control valve,
an electro-mechanical fresh-air control valve switching means, and
a connecting wire,
the connecting wire connecting the CO sensor detector, the smoke/heat detector, the power source, the heater control valve, the electro-mechanical heater control valve switching means, the fresh-air control valve, the electro-mechanical fresh-air control valve switching means and the electronic control unit together to form a circuit means,
the CO sensor detector being capable of sending a CO detection signal to the electronic control unit through the connecting wire,
the smoke/heat detector being capable of sending a fire detection signal to the electronic control unit through the connecting wire,
the electronic control unit comprising a first signal, a second signal, a third signal, a fourth signal and an over-ride signal means,
the electronic control unit, upon receiving the CO detection signal, sends the first signal through the connecting wire to the electro-mechanical heater control valve switching means on the heater control box to close the heater control valve, and sends the second signal through the connecting wire to the electro-mechanical fresh-air control valve switching means on the fresh-air control box to open the fresh-air control valve, thereby allowing fresh-air to enter and ventilate the aircraft cabin,
the electronic control unit, upon receiving the fire detection signal, sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve, thereby closing the heater control valve and closing the fresh-air control valve to prevent fire from entering the cabin,
the electronic control unit, upon receiving both the fire detection signal and the CO detection signal, provides the over-ride signal means to disregard the CO detection signal and sends the third signal through the connecting wire to the electro-mechanical heater control valve switching means on the heater control box to close the heater control valve, and sends the fourth signal through the connecting wire to the electro-mechanical fresh-air control valve switching means on the fresh-air control box to close the fresh-air control valve.
